(19) United States
(12) Patent Application Publication
(10) Pub. No.: US 2009/0115920 A1
(43) Pub. Date: May 7, 2009

(54) Liquid crystal display device and test method therefor

(75) Inventor: Shung-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN)CO., LTD.; INNOLUX DISPLAY CORP.

(21) Appl. No.: 12/290,849

(22) Filed: Nov. 3, 2008

(30) Foreign Application Priority Data
Nov. 2, 2007 (CN) 200710124259.7

(51) Int. Cl. G02F 1/13

(52) U.S. Cl. 349/1

(57) ABSTRACT

An exemplary liquid crystal display device includes scanning lines (201), data lines (202), and a control circuit (200). The control circuit includes a data driver (230), a scanning driver (220), and a DC/DC converter (260). The DC/DC converter includes a reference voltage output terminal (262), a high voltage output terminal (263), a low voltage output terminal (264), a first adjusting circuit connected to the reference voltage output terminal, a second adjusting circuit connected to the high voltage output terminal and a third adjusting circuit connected to low voltage output terminal. The first adjusting circuit includes a first terminal. The second adjusting circuit includes a second terminal. The third adjusting circuit includes a third terminal. Three voltages of the three output terminals are determined by three voltages of the three terminals of the three adjusting circuits.

The present disclosure relates to a liquid crystal display device and a test method for the liquid crystal display device.

### GENERAL BACKGROUND

A typical liquid crystal display (LCD) has the advantages of portability, low power consumption, and low radiation, and has been widely used in various portable information products such as notebooks, personal digital assistants (PDAs), video cameras and the like.

Referring to FIG. 5, a related art liquid crystal display device 10 includes a plurality of scanning lines 101, a plurality of data lines 102, a five volt (5V) power supply 110, and a control circuit 100. The scanning lines 101 and the data lines 102 cross each other, and thereby define a plurality of pixel units 103. Each pixel unit 103 includes a red sub-pixel unit R, a blue sub-pixel unit B, and a green sub-pixel unit G.

The control circuit 100 includes a scanning driver 120, a data driver 130, a timing controller 140, a step-down transformer 150, a direct current to direct current (DC/DC) converter 160, and a gamma circuit 170.

The step-down transformer 150 includes a first voltage input terminal 151 and an operation voltage output terminal 152. The first voltage input terminal 151 is connected to the 5V power supply 110. The operation voltage output terminal 152 is connected to the timing controller 140, the scanning driver 120, and the data driver 130, respectively. The operation voltage output terminal 152 is configured to provide a 3.3V operation voltage for the timing controller 140, the scanning driver 120, and the data driver 130.

The DC/DC converter 160 includes a second voltage input terminal 161, an analog voltage output terminal 162, a high voltage output terminal 163, and a low voltage output terminal 164. The second voltage input terminal 161 is connected to the 5V power supply 110. The high voltage output terminal 163 is connected to the scanning driver 120, and is configured to output a high-level voltage V_{GH} to the scanning driver 120. The low voltage output terminal 164 is connected to the scanning driver 120, and is configured to output a low-level voltage V_{GL} to the scanning driver 120. The analog voltage output terminal 162 is connected to the gamma circuit 170, and is configured to output a reference voltage V_{AVDD} to the gamma circuit 170. The gamma circuit 170 is configured to transform the reference voltage V_{AVDD} to a plurality of gray voltages according to gray levels which the liquid crystal display device 10 displays, and output the gray voltages to the data driver 130. Each gray voltage corresponds to a display gray level. The high-level voltage V_{GH} can, for example, be 26V. The low-level voltage V_{GL} can, for example, be −6V. The reference voltage V_{AVDD} can, for example, be 12.75V.

The scanning driver 120 is configured to receive the high-level voltage V_{GH} and the low-level voltage V_{GL}, and output a plurality of scanning voltages to each scanning line 101 in turn.

The timing controller 140 is configured to receive an external low voltage differential signal (LVDS), and output a plurality of red digital signals, a plurality of green digital signals and a plurality of blue digital signals to the data driver 130.

The data driver 130 is configured to transform the red digital signals, the green digital signals and the blue digital signals to corresponding red analog signals, green analog signals and blue analog signals. Each red analog signal, each green analog signal and each blue analog signal respectively correspond to a display gray level of a red sub-pixel unit, a display gray level of a green sub-pixel unit and a display gray level of a blue sub-pixel unit. The data driver 130 is also configured to select gray voltages according to the red analog signals, the green analog signals and the blue analog signals, and output the gray voltages to the data lines 102.

Referring to FIG. 6, when the liquid crystal display device 10 is in a test mode, the 5V power supply 110 is off, and a high voltage stress connector 111 is provided. The high voltage stress connector 111 provides test signals to the liquid crystal display device 10. The high voltage stress connector 111 includes a first output terminal 121, a second output terminal 122, a third output terminal 123, a fourth output terminal 124, and a fifth output terminal 125.

The first output terminal 121 is respectively connected to the scanning driver 120, the data driver 130 and the timing controller 140, and provides 3.3V operation voltages for the scanning driver 120, the data driver 130 and the timing controller 140. The second output terminal 122 and the third output terminal 123 are respectively connected to the scanning driver 120, for providing a high-level voltage V_{GH1} and a low-level voltage V_{GL1}. The fourth output terminal 124 is connected to the timing controller 140, for providing an enabling signal. The enabling signal is configured to enable a test system (not shown) of the liquid crystal display device 10, so as to display a predetermined test picture. The fifth output terminal 125 is connected to the gamma circuit 170, for providing a reference voltage V_{AVDD1}.

The high-level voltage V_{GH1} is higher than the high-level voltage V_{GH}. The high-level voltage V_{GH1} can be 30V. The low-level voltage V_{GL1} is lower than the low-level voltage V_{GL}. The low-level voltage V_{GL1} can be −8V. The reference voltage V_{AVDD1} is higher than the reference voltage V_{AVDD}. The reference voltage V_{AVDD1} can be 13.5V.

When the second output terminal 122 outputs the high-level voltage V_{GH1} to the scanning driver 120, the high-level voltage V_{GH1} is also provided to the DC/DC converter 160. Because the DC/DC converter 160 is off, the high-level voltage V_{GH1} is liable to lead to incorrect operation of an internal circuit of the DC/DC converter 160, and even destroy the DC/DC converter 160. In a mass testing facility, a burnout rate of the DC/DC converter 160 can be as high as ten percent. Thus when the liquid crystal display device 10 is tested, the reliability of the testing process is low.

It is desired to provide a new liquid crystal display device which can overcome the above-described deficiencies. It is also desired to provide a new test method for the liquid crystal display device which can overcome the above-described deficiencies.

### SUMMARY

In one exemplary embodiment, a liquid crystal display device includes a plurality of scanning lines, a plurality of data lines and a control circuit. The control circuit includes a data driver, a scanning driver and a direct current to direct current (DC/DC) converter. The DC/DC converter includes an analog voltage output terminal, a high voltage output terminal, a low voltage output terminal, a first adjusting circuit, a second adjusting circuit, and a third adjusting circuit. The analog voltage output terminal is capable of outputting a reference voltage. The high voltage output terminal is capable of outputting a high-level voltage. The low voltage output terminal is capable of outputting a low-level voltage. The first adjusting circuit is connected to the analog voltage output terminal. The second adjusting circuit is connected to the high voltage output terminal. The third adjusting circuit is connected to the low voltage output terminal. The scanning driver is configured to receive the high-level voltage and the low-level voltage, and outputs a plurality of scanning voltages to each scanning line in turn. The data driver is configured to receive the reference voltage, and outputs a plurality of gray voltages to the data lines. The first adjusting circuit includes a first terminal. The second adjusting circuit includes a second terminal. The third adjusting circuit includes a third terminal. Three voltages of the three output terminals are determined by three voltages of the three terminals of the three adjusting circuits.

Other novel features and advantages will become more apparent from the following detailed description when taken in conjunction with the accompanying drawings.

### BRIEF DESCRIPTION OF THE DRAWINGS

FIG. 1 is a circuit diagram of a liquid crystal display device according to a first embodiment of the present disclosure, the liquid crystal display device including a DC/DC converter.

FIG. 2 is a circuit diagram of the DC/DC converter of the liquid crystal display device of FIG. 1.

FIG. 3 is a circuit diagram of the liquid crystal display device of FIG. 1 together with a high voltage stress connector.

FIG. 4 is a circuit diagram of a DC/DC converter of a liquid crystal display device according to a second embodiment of the present disclosure.

FIG. 5 is a circuit diagram of a related art liquid crystal display device.

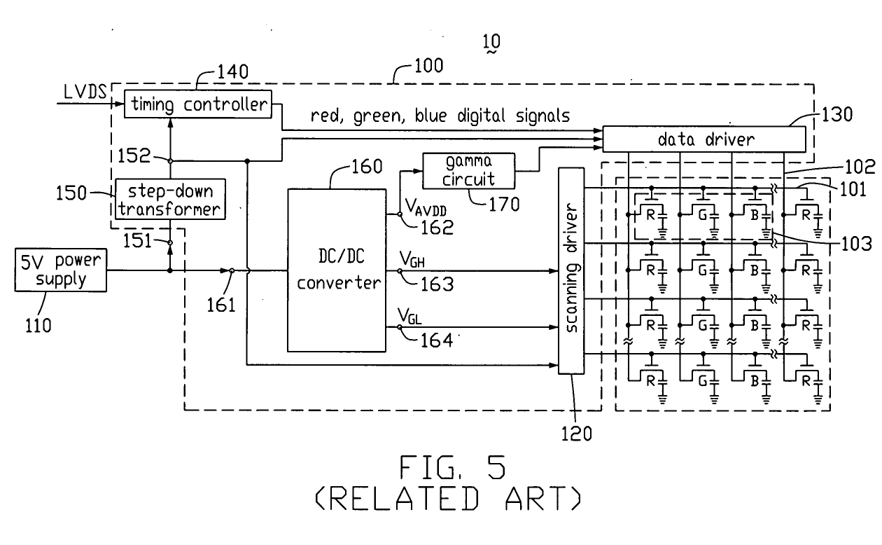

FIG. 6 is a circuit diagram of the liquid crystal display device of FIG. 5 together with a high voltage stress connector.

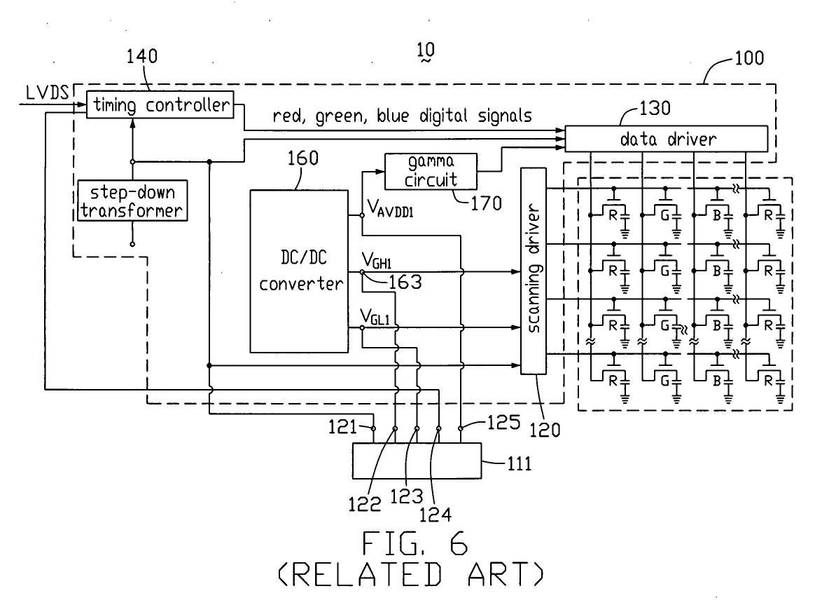

### DETAILED DESCRIPTION OF EMBODIMENTS

Reference will now be made to the drawings to describe preferred and exemplary embodiments of the present disclosure in detail.

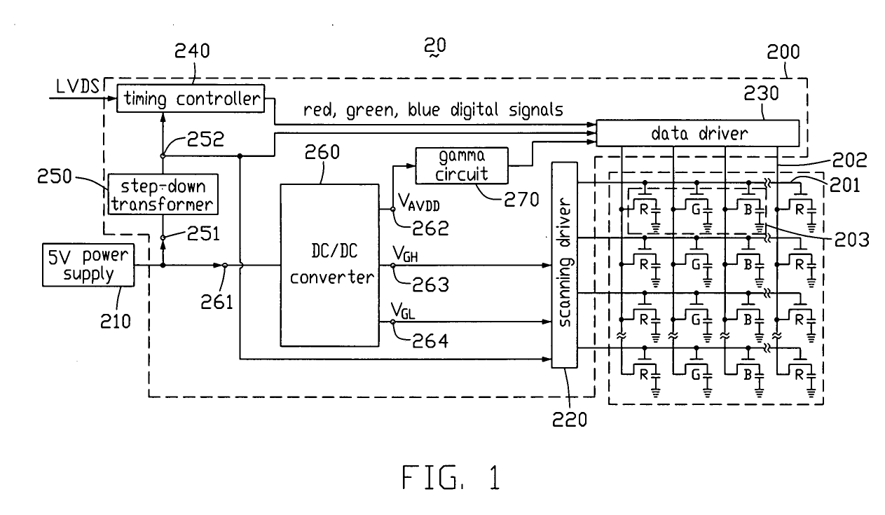

Referring to FIG. 1, this is a circuit diagram of a liquid crystal display device according to a first embodiment of the present disclosure. The liquid crystal display device 20 includes a plurality of scanning lines 201, a plurality of data lines 202, a 5V power supply 210, and a control circuit 200. The scanning lines 201 and the data lines 202 cross each other, and thereby define a plurality of pixel units 203. Each pixel unit 203 includes a red sub-pixel unit R, a blue sub-pixel unit B, and a green sub-pixel unit G.

The control circuit 200 includes a scanning driver 220, a data driver 230, a timing controller 240, a step-down transformer 250, a DC/DC converter 260, and a gamma circuit 270.

The step-down transformer 250 includes a first voltage input terminal 251 and an operation voltage output terminal 252. The first voltage input terminal 251 is connected to the 5V power supply 210. The operation voltage output terminal 252 is connected to the timing controller 240, the scanning driver 220 and the data driver 230, respectively. The operation voltage output terminal 252 is configured to provide 3.3V operation voltages for the timing controller 240, the scanning driver 220 and the data driver 230.

The DC/DC converter 260 includes a second voltage input terminal 261, an analog voltage output terminal 262, a high voltage output terminal 263, and a low voltage output terminal 264. The second voltage input terminal 261 is connected to the 5V power supply 210. The high voltage output terminal 263 is connected to the scanning driver 220, and is configured to output a high-level voltage V_{GH} to the scanning driver 220. The low voltage output terminal 264 is connected to the scanning driver 220, and is configured to output a low-level voltage V_{GL} to the scanning driver 220. The analog voltage output terminal 262 is connected to the gamma circuit 270, and is configured to output a reference voltage V_{AVDD} to the gamma circuit 270. The gamma circuit 270 is configured to transform the reference voltage V_{AVDD} to a plurality of gray voltages according to gray levels which the liquid crystal display device 20 displays, and output the gray voltages to the data driver 230. Each gray voltage corresponds to a display gray level. The high-level voltage V_{GH} can, for example, be 26V. The low-level voltage V_{GL} can, for example, be −6V. The reference voltage V_{AVDD} can, for example, be 12.75V.

The scanning driver 220 is configured to receive the high-level voltage V_{GH} and the low-level voltage V_{GL}, and output a plurality of scanning voltages to each scanning line 201 in turn.

The timing controller 240 is configured to receive an external low voltage differential signal (LVDS), and output a plurality of red digital signals, a plurality of green digital signals and a plurality of blue digital signals to the data driver 230.

The data driver 230 is configured to transform the red digital signals, the green digital signals and the blue digital signals to corresponding red analog signals, green analog signals and blue analog signals. Each red analog signal, each green analog signal and each blue analog signal respectively correspond to a display gray level of a red sub-pixel unit, a display gray level of a green sub-pixel unit and a display gray level of a blue sub-pixel unit. The data driver 230 is also configured to select gray voltages according to the red analog signals, the green analog signals and the blue analog signals, and output the gray voltages to the data lines 202.

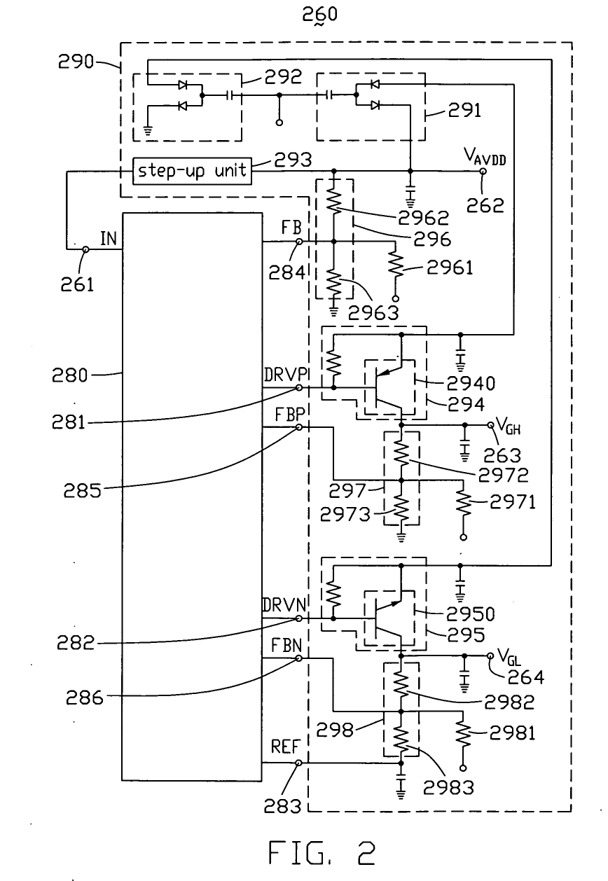

Referring to FIG. 2, this is a circuit diagram of the DC/DC converter 260. The DC/DC converter 260 includes a step-up transformer 280 and a periphery circuit 290. The step-up transformer 280 can be a MAX1518 model. The MAX1518 model is available from Maxim Integrated Products Inc., of 120 San Gabriel Drive, Sunnyvale, Calif. 94086, U.S.A. The step-up transformer 280 includes a first modulation terminal 281, a second modulation terminal 282, a reference terminal 283, a first feedback terminal 284, a second feedback terminal 285, and a third feedback terminal 286. The second voltage input terminal 261 is connected to an input pin IN of the step-up transformer 280. The first modulation terminal 281 is a first modulation pin DRVP of the step-up transformer 280. The second modulation terminal 282 is a second modulation pin DRVN of the step-up transformer 280. The first feedback terminal 284 is a first feedback pin FB of the step-up transformer 280. The second feedback terminal 285 is a second feedback pin FBP of the step-up transformer 280. The third feedback terminal 286 is a third feedback pin FBN of the step-up transformer 280. The reference terminal 283 is a reference pin REF of the step-up transformer 280.

The periphery circuit 290 includes a first charge pump 291, a second charge pump 292, a step-up unit 293, a first step-down circuit 294, a second step-down circuit 295, a first feedback circuit 296, a second feedback circuit 297, a third feedback circuit 298, a first resistor 2961, a second resistor 2971, and a third resistor 2981. The first feedback circuit 296 includes a fourth resistor 2962 and a fifth resistor 2963 connected in series. The second feedback circuit 297 includes a sixth resistor 2972 and a seventh resistor 2973 connected in series. The third feedback 298 circuit includes an eighth resistor 2982 and a ninth resistor 2983 connected in series.

The second voltage input terminal 261 is connected to the analog voltage output terminal 262 via the step-up unit 293. The first charge pump 291 is configured to double the reference voltage V_{AVDD}. The first step-down circuit 294 is configured to transform the doubled reference voltage 2V_{AVDD} to the high-level voltage V_{GH}, and provide the high-level voltage V_{GH} to the high voltage output terminal 263. The second charge pump 292 is configured to transform the reference voltage V_{AVDD} to a negative reference voltage −V_{AVDD}. The second step-down circuit 295 is configured to transform the negative reference voltage −V_{AVDD} to the low-level voltage V_{GL}, and provide the low-level voltage V_{GL} to the low voltage output terminal 264.

The analog voltage output terminal 262 is grounded via the fourth resistor 2962 and the fifth resistor 2963 in series. The first feedback terminal 284 is connected to a node between the fourth resistor 2962 and the fifth resistor 2963. One terminal of the first resistor 2961 is connected to the first feedback terminal 284, and the other terminal of the first resistor 2961 is floating.

The first step-down circuit 294 includes a positive-negative-positive (PNP) semiconductor triode 2940. A base electrode of the PNP semiconductor triode 2940 is connected to the first modulation terminal 281. An emitter electrode of the PNP semiconductor triode 2940 is connected to the analog voltage output terminal 262 via the first charge pump 291. A collector electrode of the PNP semiconductor triode 2940 is connected to the high voltage output terminal 263, and is also grounded via the sixth resistor 2972 and the seventh resistor 2973 in series. The second feedback terminal 285 is connected to a node between the sixth resistor 2972 and the seventh resistor 2973. One terminal of the second resistor 2971 is connected to the second feedback terminal 285, and the other terminal of the second resistor 2971 is floating.

The second step-down circuit 295 includes a negative-positive-negative (NPN) semiconductor triode 2950. A base electrode of the NPN semiconductor triode 2950 is connected to the second modulation terminal 282. An emitter electrode of the NPN semiconductor triode 2950 is connected to the analog voltage output terminal 262 via the second charge pump 292 and the first charge pump 291 in turn. A collector electrode of the NPN semiconductor triode 2950 is connected to the low voltage output terminal 264, and is also connected to the reference terminal 283 via the eighth resistor 2982 and the ninth resistor 2983 in series. The third feedback terminal 286 is connected to a node between the eighth resistor 2982 and the ninth resistor 2983. One terminal of the third resistor 2981 is connected to the third feedback terminal 286, and the other terminal of the third resistor 2981 is floating.

A resistance of the first resistor 2961 can, for example, be thirteen thousand ohms (13,000 Ω). A resistance of the second resistor 2971 can, for example, be three hundred and twenty thousand ohms (320,000 Ω). A resistance of the third resistor 2981 can, for example, be one hundred thousand ohms (100,000 Ω). A resistance of the fourth resistor 2962 can, for example, be eight thousand two hundred ohms (8,200 Ω). A resistance of the fifth resistor 2963 can, for example, be eight hundred and forty-five ohms (845 Ω). A resistance of the sixth resistor 2972 can, for example, be twenty-four thousand ohms (24,000 Ω). A resistance of the seventh resistor 2973 can, for example, be one thousand two hundred and ten ohms (1,210 Ω). A resistance of the eighth resistor 2982 can, for example, be twenty-four thousand ohms (24,000 Ω). A resistance of the ninth resistor 2983 can, for example, be one thousand two hundred and ten ohms (1,210 Ω).

When the liquid crystal display device 20 operates, the reference voltage V_{AVDD}, the high-level voltage V_{GH} and the low-level voltage V_{GL} can be expressed according to following formulas.

V_{AVDD}=V_{FB}(R₄+R₅)/R₅ (1)

The symbol V_{FB} denotes a voltage of the first feedback terminal 284. The symbol R₄ denotes a resistance of the fourth resistor 2962. The symbol R₅ denotes a resistance of the fifth resistor 2963.

V_{GH}=V_{FBP}(R₆+R₇)/R₇ (2)

The symbol V_{FBP} denotes a voltage of the second feedback terminal 285. The symbol R₆ denotes a resistance of the sixth resistor 2972. The symbol R₇ denotes a resistance of the seventh resistor 2973.

V_{GL}=V_{FBN}−(V_{REF}−V_{FBN})R₈/R₉ (3)

The symbol V_{FBN} denotes a voltage of the third feedback terminal 286. The symbol V_{REF} denotes a voltage of the reference terminal 283. The symbol R₈ denotes a resistance of the eighth resistor 2982. The symbol R₉ denotes a resistance of the ninth resistor 2983.

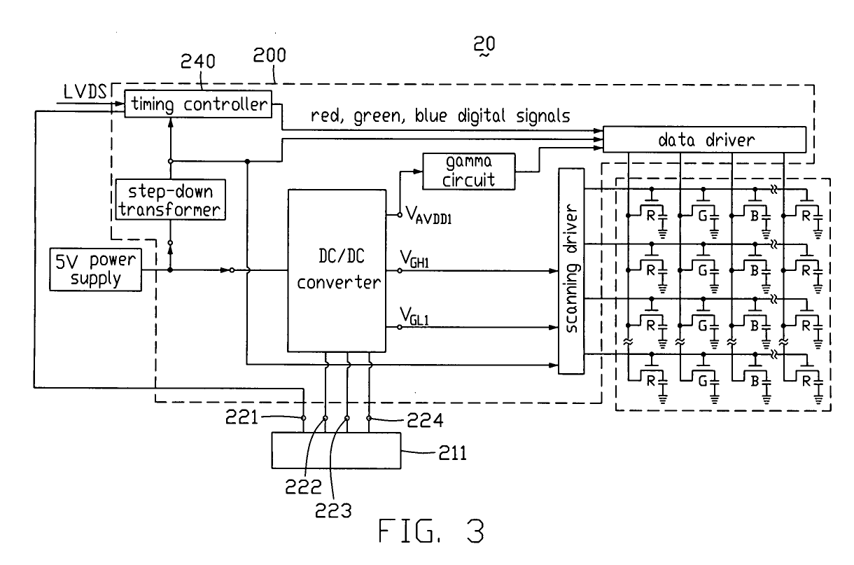

FIG. 3 is a circuit diagram of the liquid crystal display device 20 together with a high voltage stress connector 211. When the liquid crystal display device 20 is in the test mode, the 5V power supply 210 continues to function, and the high voltage stress connector 211 is connected to the control circuit 200. The high voltage stress connector 211 includes an output terminal 221, a first connecting terminal 222, a second connecting terminal 223, and a third connecting terminal 224.

The output terminal 221 is connected to the timing controller 240, for providing an enabling signal. The enabling signal is configured to enable a test system (not shown) of the liquid crystal display device 20, so as to display a predetermined test picture. The first connecting terminal 222 is connected to the floating terminal of the first resistor 2961 of the DC/DC converter 260, and is also grounded. The second connecting terminal 223 is connected to the floating terminal of the second resistor 2971 of the DC/DC converter 260, and is also grounded. The third connecting terminal 224 is connected to the floating terminal of the third resistor 2981 of the DC/DC converter 260. A voltage which is equal to a voltage of the reference terminal 283 is provided to the third connecting terminal 224. Therefore, the first resistor 2961 is connected in parallel with the fifth resistor 2963. The second resistor 2971 is connected in parallel with the seventh resistor 2973. The third resistor 2981 is connected in parallel with the ninth resistor 2983.

Because the 5V power supply 210 is still provided for the control circuit 200, the DC/DC converter 260 keeps working. The analog voltage output terminal 262, the high voltage output terminal 263 and the low voltage output terminal 264 respectively output a reference voltage V_{AVDD1}, a high-level voltage V_{GH1} and a low-level voltage V_{GL1}. The reference voltage V_{AVDD1}, the high-level voltage V_{GH1} and the low-level voltage V_{GL1} can be expressed by the following formulas.

V_{AVDD1}=V_{FB}(R₄+R₅″)/R₅″ (4)

The symbol V_{FB} denotes a voltage of the first feedback terminal 284. The symbol R₄ denotes a resistance of the fourth resistor 2962. The symbol R₅″ denotes a total resistance of the first resistor 2961 and the fifth resistor 2963 that are connected in parallel, and R₅″<R₅.

V_{GH1}=V_{FBP}(R₆+R₇″)/R₇″ (5)

The symbol V_{FBP} denotes a voltage of the second feedback terminal 285. The symbol R₆ denotes a resistance of the sixth resistor 2972. The symbol R₇″ denotes a total resistance of the second resistor 2971 and the seventh resistor 2973 that are connected in parallel, and R₇″<R₇.

V_{GL1}=V_{FBN}−(V_{REF}−V_{FBN})R₈/R₉″ (6)

The symbol V_{FBN} denotes a voltage of the third feedback terminal 286. The symbol V_{REF} denotes the voltage of the reference terminal 283. The symbol R₈ denotes a resistance of the eighth resistor 2982. The symbol R₉″ denotes a total resistance of the third resistor 2981 and the ninth resistor 2983 that are connected in parallel, and R₉″<R₉.

Therefore, V_{AVDD1}>V_{AVDD}, V_{GH1}>V_{GH}, and V_{GL1}>V_{GL}. V_{AVDD1}, V_{GH1} and V_{GL1} can respectively reach test voltages through appropriate setting (selecting) of the resistances of the first resistor 2961, the second resistor 2971 and the third resistor 2981. For example, V_{GH1} can be 30V, V_{GL1} can be −8V, and V_{AVDD1} can be 13.5V.

The DC/DC converter 260 includes the first resistor 2961, the second resistor 2971, and the third resistor 2981. The three resistors 2961, 2971, 2981 are floating when the liquid crystal display device 20 operates. When the liquid crystal display device 20 is tested, the three resistors 2961, 2971, 2981 are respectively connected in parallel with the fifth resistor 2963, the seventh resistor 2973 and the ninth resistor 2983. The voltages of the analog voltage output terminal 262, the high voltage output terminal 263 and the low voltage output terminal 264 increase when the liquid crystal display device 20 is tested. In other words, the voltages of the three output terminals 262, 263, 264 can reach V_{AVDD1}, V_{GH1} and V_{GL1} when the liquid crystal display device 20 is tested. Therefore the liquid crystal display device 20 does not require the high voltage stress connector 211 to provide voltages thereto. Thus the DC/DC converter 260 is not liable to be destroyed by a high-level test voltage, and the liquid crystal display device 20 has high reliability when tested.

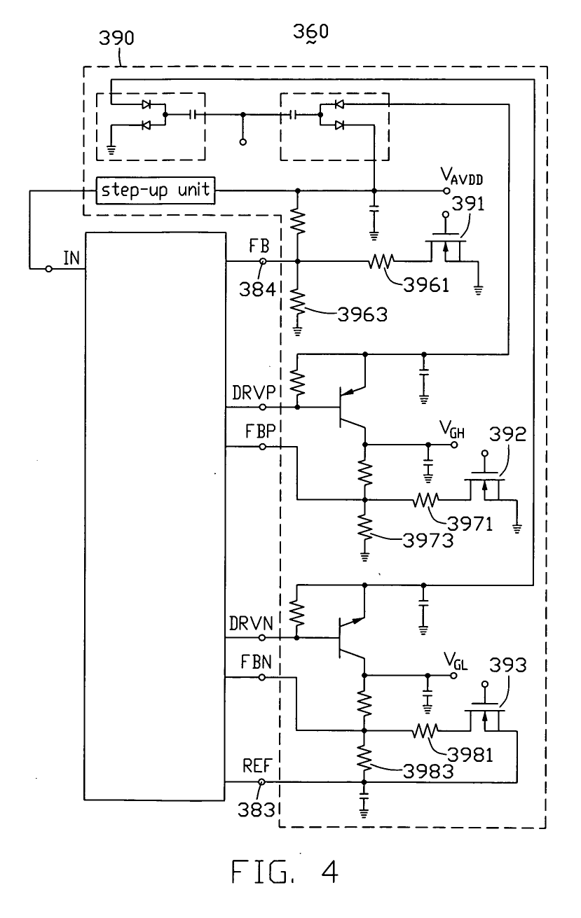

FIG. 4 is a circuit diagram of a DC/DC converter 360 of a liquid crystal display device according to a second embodiment of the present disclosure. Differences between the DC/DC converter 360 of the second embodiment and the DC/DC converter 260 of the first embodiment are as follows. A periphery circuit 390 of the DC/DC converter 360 further includes a first switch 391, a second switch 392, and a third switch 393. The first switch 391 is a transistor. A gate electrode of the first switch 391 is floating. A source electrode of the first switch 391 is grounded. A drain electrode of the first switch 391 is connected to a first feedback terminal 384 via a first resistor 3961. The second switch 392 and the third switch 393 are similar to the first switch 391 respectively. In general, connections of electrodes of the second switch 392 and the third switch 393 are similar to those of the first switch 391 respectively. However, one difference is that a source electrode of the third switch 393 is connected to a reference terminal 383.

When the liquid crystal display device of the second embodiment is in a test mode, a first connecting terminal of a high voltage stress connector (not shown) is connected to the gate electrode of the first switch 391, a second connecting terminal of the high voltage stress connector is connected to a gate electrode of the second switch 392, and a third connecting terminal of the high voltage stress connector is connected to a gate electrode of the third switch 393. The three connecting terminals provide high voltages, so the three switches 391, 392, 393 are turned on. Therefore, the first resistor 3961 is connected in parallel with a fifth resistor 3963. A second resistor 3971 is connected in parallel with a seventh resistor 3973. A third resistor 3981 is connected in parallel with a ninth resistor 3983.

In various alternative embodiments, the first connecting terminal 222 and the second connecting terminal 223 of the high voltage stress connector 211 of the first embodiment can be connected to a low voltage when the liquid crystal display device 20 is tested. The low voltage can be 1V, 2V, etc, on condition that voltages of the analog voltage output terminal 262 and the high voltage output terminal 263 can be increased to predetermined levels.

When the liquid crystal display device 20 of the first embodiment is tested, the third connecting terminal 224 of the high voltage stress connector 211 can be grounded.

The emitter electrode of the third switch 393 of the DC/DC converter 360 of the second embodiment can be grounded.

The model of the step-up transformer 280 of the DC/DC converter 260 of the first embodiment can be AAT1168B, or another suitable model.

In the above-described first embodiment, the DC/DC converter 260 uses three adjusting circuits which include the three resistors 2961, 2971, 2981 and the three feedback circuits 296, 297, 298. In alternative embodiments, the DC/DC converter 260 can use three adjusting circuits of another kind, which adjusting circuits have the same function of increasing the voltages of the three output terminals 262, 263, 264.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the disclosure to the full extent indicated by the broad general meaning of the terms in which the appended claims are expressed.

What is claimed is:

1. A liquid crystal display device, comprising:
a plurality of scanning lines;
a plurality of data lines; and
a control circuit, comprising:
a data driver;
a scanning driver; and
a direct current to direct current (DC/DC) converter, comprising:
an analog voltage output terminal capable of outputting a reference voltage;
a high voltage output terminal capable of outputting a high-level voltage;
a low voltage output terminal capable of outputting a low-level voltage;
a first adjusting circuit connected to the analog voltage output terminal;
a second adjusting circuit connected to the high voltage output terminal; and
a third adjusting circuit connected to the low voltage output terminal;
the scanning driver being configured to receive the high-level voltage and the low-level voltage, and output a plurality of scanning voltages to each scanning line in turn; and the data driver being configured to receive the reference voltage, and output a plurality of gray voltages to the data lines;
wherein, the first adjusting circuit comprises a first terminal, the second adjusting circuit comprises a second terminal, and the third adjusting circuit comprises a third terminal, three voltages of the three output terminals being determined by three voltages of the three terminals of the three adjusting circuits.

2. The liquid crystal display device of claim 1, wherein the DC/DC converter further comprises a step-up transformer, the step-up transformer comprises a reference terminal, a first feedback terminal, a second feedback terminal, and a third feedback terminal, the first adjusting circuit further comprises a first resistor, a fourth resistor, and a fifth resistor, one terminal of the first resistor is connected to the first feedback terminal, the other terminal of the first resistor is floating, the analog voltage output terminal is grounded via the fourth resistor and the fifth resistor in series, the first feedback terminal is connected to a node between the fourth resistor and the fifth resistor, the second adjusting circuit further comprises a second resistor, a sixth resistor, and a seventh resistor, one terminal of the second resistor is connected to the second feedback terminal, the other terminal of the second resistor is floating, the high voltage output terminal is grounded via the sixth resistor and the seventh resistor in series, the second feedback terminal is connected to a node between the sixth resistor and the seventh resistor, the third adjusting circuit further comprises a third resistor, an eighth resistor and a ninth resistor, one terminal of the third resistor is connected to the third feedback terminal, the other terminal of the third resistor is floating, the low voltage output terminal is connected to the reference terminal via the eighth resistor and the ninth resistor in series, the third feedback terminal is connected to a node between the eighth resistor and the ninth resistor, the first terminal is the floating terminal of the first resistor, the second terminal is the floating terminal of the second resistor, and the third terminal is the floating terminal of the third resistor.

3. The liquid crystal display device of claim 2, wherein the DC/DC converter further comprises a voltage input terminal capable of being connected to a five volt power supply.

4. The liquid crystal display device of claim 3, wherein the DC/DC converter further comprises a step-up unit, and the voltage input terminal is connected to the analog voltage output terminal via the step-up unit.

5. The liquid crystal display device of claim 4, wherein the DC/DC converter further comprises a first charge pump and a first step-down circuit, the first charge pump is configured to double the reference voltage, and the first step-down circuit is configured to transform the doubled reference voltage to the high-level voltage and provide the high-level voltage to the high voltage output terminal.

6. The liquid crystal display device of claim 5, wherein the step-up transformer further comprises a first modulation terminal, the first step-down circuit comprises a positive-negative-positive (PNP) semiconductor triode, a base electrode of the PNP semiconductor triode is connected to the first modulation terminal, an emitter electrode of the PNP semiconductor triode is connected to the analog voltage output terminal via the first charge pump, and a collector electrode of the PNP semiconductor triode is connected to the high-level voltage output terminal.

7. The liquid crystal display device of claim 5, wherein the DC/DC converter further comprises a second charge pump and a second step-down circuit, the second charge pump is configured to transform the reference voltage to a negative reference voltage, and the second step-down circuit is configured to transform the negative reference voltage to the low-level voltage and provide the low-level voltage to the low voltage output terminal.

8. The liquid crystal display device of claim 7, wherein the step-up transformer further comprises a second modulation terminal, the second step-down circuit comprises a negative-positive-negative (NPN) semiconductor triode, a base electrode of the NPN semiconductor triode is connected to the second modulation terminal, an emitter electrode of the NPN semiconductor triode is connected to the reference voltage output terminal via the second charge pump and the first charge pump in turn, and a collector electrode of the NPN semiconductor triode is connected to the low voltage output terminal.

9. The liquid crystal display device of claim 1, wherein the DC/DC converter further comprises a step-up transformer, the step-up transformer comprises a reference terminal, a first feedback terminal, a second feedback terminal, and a third feedback terminal, the first adjusting circuit further comprises a first switch, a first resistor, a fourth resistor, and a fifth resistor, one terminal of the first resistor is connected to the first feedback terminal, the other terminal of the first resistor is grounded via the first switch, the reference voltage output terminal is grounded via the fourth resistor and the fifth resistor in series, the first feedback terminal is connected to a node between the fourth resistor and the fifth resistor, the second adjusting circuit further comprises a second switch, a second resistor, a sixth resistor, and a seventh resistor, one terminal of the second resistor is connected to the second feedback terminal, the other terminal of the second resistor is grounded via the second switch, the high voltage output terminal is grounded via the sixth resistor and the seventh resistor in series, the second feedback terminal is connected to a node between the sixth resistor and the seventh resistor, the third adjusting circuit further comprises a third switch, a third resistor, an eighth resistor, and a ninth resistor, one terminal of the third resistor is connected to the third feedback terminal, the other terminal of the third resistor is connected to the reference terminal via the third switch, the low voltage output terminal is connected to the reference terminal via the eighth resistor and the ninth resistor in series, the third feedback terminal is connected to a node between the eighth resistor and the ninth resistor, and three control terminals of the three switches are the three terminals of the three adjusting circuits.

10. The liquid crystal display device of claim 9, wherein the first switch comprises a transistor, a gate electrode of the first switch is floating, a source electrode of the first switch is grounded, and a drain electrode of the first switch is connected to the first feedback terminal via the first resistor.

11. The liquid crystal display device of claim 10, wherein the second switch comprises a transistor, a gate electrode of the second switch is floating, a source electrode of the second switch is grounded, and a drain electrode of the second switch is connected to the second feedback terminal via the second resistor.

12. The liquid crystal display device of claim 11, wherein the third switch comprises a transistor, a gate electrode of the third switch is floating, a source electrode of the third switch is connected to the reference terminal, and a drain electrode of the third switch is connected to the third feedback terminal via the third resistor.

13. A test method for the liquid crystal display device of claim 1, the method comprising:
providing an operating voltage for the control circuit;
connecting a connector to the control circuit, the connector comprising a first connecting terminal, a second connecting terminal, and a third connecting terminal, the three connecting terminals being respectively connected to the three terminals of the three adjusting circuits; and
controlling voltages of the three output terminals by controlling the three voltages of the three connecting terminals.

14. The test method of claim 13, wherein the DC/DC converter further comprises a step-up transformer, the step-up transformer comprises a reference terminal, a first feedback terminal, a second feedback terminal, and a third feedback terminal, the first adjusting circuit further comprises a first resistor, a fourth resistor, and a fifth resistor, one terminal of the first resistor is connected to the first feedback terminal, the other terminal of the first resistor is floating, the analog voltage output terminal is grounded via the fourth resistor and the fifth resistor in series, the first feedback terminal is connected to a node between the fourth resistor and the fifth resistor, the second adjusting circuit further comprises a second resistor, a sixth resistor, and a seventh resistor, one terminal of the second resistor is connected to the second feedback terminal, the other terminal of the second resistor is floating, the high voltage output terminal is grounded via the sixth resistor and the seventh resistor in series, the second feedback terminal is connected to a node between the sixth resistor and the seventh resistor, the third adjusting circuit further comprises a third resistor, an eighth resistor and a ninth resistor, one terminal of the third resistor is connected to the third feedback terminal, the other terminal of the third resistor is floating, the low voltage output terminal is connected to the reference terminal via the eighth resistor and the ninth resistor in series, the third feedback terminal is connected to a node between the eighth resistor and the ninth resistor, the first terminal is the floating terminal of the first resistor, the second terminal is the floating terminal of the second resistor, the third terminal is the floating terminal of the third resistor, and in the test method, the first connecting terminal and the second connecting terminal are grounded, and the third connecting terminal is connected to a voltage which is equal to a voltage of the reference terminal.

15. The test method of claim 14, wherein the liquid crystal display device further comprises a timing controller and a test system, the timing controller is configured to receive an external low voltage differential signal and output a plurality of digital signals to the data driver, the connector further comprises an output terminal connected to the timing controller, and the output terminal is capable of providing an enabling signal that enables the test system of the liquid crystal display device to display a predetermined test picture.

16. The test method of claim 13, wherein the DC/DC converter further comprises a step-up transformer, the step-up transformer comprises a reference terminal, a first feedback terminal, a second feedback terminal, and a third feedback terminal, the first adjusting circuit further comprises a first switch, a first resistor, a fourth resistor, and a fifth resistor, one terminal of the first resistor is connected to the first feedback terminal, the other terminal of the first resistor is grounded via the first switch, the reference voltage output terminal is grounded via the fourth resistor and the fifth resistor in series, the first feedback terminal is connected to a node between the fourth resistor and the fifth resistor, the second adjusting circuit further comprises a second switch, a second resistor, a sixth resistor, and a seventh resistor, one terminal of the second resistor is connected to the second feedback terminal, the other terminal of the second resistor is grounded via the second switch, the high voltage output terminal is grounded via the sixth resistor and the seventh resistor in series, the second feedback terminal is connected to a node between the sixth resistor and the seventh resistor, the third adjusting circuit further comprises a third switch, a third resistor, an eighth resistor, and a ninth resistor, one terminal of the third resistor is connected to the third feedback terminal, the other terminal of the third resistor is connected to the reference terminal via the third switch, the low voltage output terminal is connected to the reference terminal via the eighth resistor and the ninth resistor in series, the third feedback terminal is connected to a node between the eighth resistor and the ninth resistor, three control terminals of the three switches are the three terminals of the three adjusting circuits, and the test method further comprises turning on the three switches through control of the three voltages of the three connecting terminals.

17. The test method of claim 16, wherein the liquid crystal display device further comprises a timing controller and a test system, the timing controller is configured to receive an external low voltage differential signal and output a plurality of digital signals to the data driver, the connector further comprises an output terminal connected to the timing controller, and the output terminal is capable of providing an enabling signal that enables the test system of the liquid crystal display device to display a predetermined test picture.

18. A liquid crystal display device, comprising:
a plurality of scanning lines;
a plurality of data lines; and
a control circuit, comprising:
a data driver;
a scanning driver; and
a direct current to direct current (DC/DC) converter, comprising:
an analog voltage output terminal capable of outputting a reference voltage;
a high voltage output terminal capable of outputting a high-level voltage;
a low voltage output terminal capable of outputting a low-level voltage;
a first adjusting circuit connected to the analog voltage output terminal;
a second adjusting circuit connected to the high voltage output terminal; and
a third adjusting circuit connected to the low voltage output terminal;
the scanning driver being configured to receive the high-level voltage and the low-level voltage, and output a plurality of scanning voltages to each scanning line in turn; and the data driver being configured to receive the reference voltage, and output a plurality of gray voltages to the data lines;
wherein, three voltages of the three output terminals are determined by three resistances of the three adjusting circuits.

19. The liquid crystal display device of claim 18, wherein the DC/DC converter further comprises a step-up transformer, the step-up transformer comprises a first feedback terminal, a second feedback terminal, and a third feedback terminal, the first adjusting circuit comprises a first feedback circuit and a first resistor, the first feedback circuit is configured to feed back a voltage of the analog voltage output terminal to the first feedback terminal, one terminal of the first resistor is connected to the first feedback terminal, the other terminal of the first resistor is floating, the second adjusting circuit comprises a second feedback circuit and a second resistor, the second feedback circuit is configured to feed back a voltage of the high voltage output terminal to the second feedback terminal, one terminal of the second resistor is connected to the second feedback terminal, the other terminal of the second resistor is floating, the third adjusting circuit comprises a third feedback circuit and a third resistor, the third feedback circuit is configured to feed back a voltage of the low voltage output terminal to the third feedback terminal, one terminal of the third resistor is connected to the third feedback terminal, the other terminal of the third resistor is floating, and three resistances of the three feedback circuits are determined by three voltages of the three floating terminals.

20. The liquid crystal display device of claim 18, wherein the DC/DC converter further comprises a step-up transformer, the step-up transformer comprises a reference terminal, a first feedback terminal, a second feedback terminal, and a third feedback terminal, the first adjusting circuit comprises a first switch, a first resistor, and a first feedback circuit, the first feedback circuit is configured to feed back a voltage of the analog voltage output terminal to the first feedback terminal, one terminal of the first resistor is connected to the first feedback terminal, the other terminal of the first resistor is grounded via the first switch, the second adjusting circuit comprises a second switch, a second resistor, and a second feedback circuit, the second feedback circuit is configured to feed back a voltage of the high voltage output terminal to the second feedback terminal, one terminal of the second resistor is connected to the second feedback terminal, the other terminal of the second resistor is grounded via the second switch, the third adjusting circuit comprises a third switch, a third resistor, and a third feedback circuit, the third feedback circuit is configured to feed back a voltage of the low voltage output terminal to the third feedback terminal, one terminal of the third resistor is connected to the third feedback terminal, the other terminal of the third resistor is connected to the reference terminal via the third switch, and three resistances of the three feedback circuits are determined by three voltages of three control terminals of the three switches.
